(19) United States
(12) Patent Application Publication
(10) Pub. No.: US 2015/0253463 A1
(43) Pub. Date: Sep. 10, 2015

(54) Generating an Ensemble of Forecasting Models

(71) Applicants: Universiti Brunei Darussalam, Gadong (BN); International Business Machines Corporation, Armonk, NY (US)

(72) Inventors: Balakrishnan Narayanaswamy, Bangalore (IN); Thomas George, Bangalore (IN); Yogish Sabharwal, Haryana (IN); Lalit Kumar Dagar, Gadong (BN); Saiful Azmi bin Hj Husain, Gadong (BN); Abd Ghani bin Hj Naim, Gadong (BN)

(73) Assignees: Universiti Brunei Darussalam, Gadong (BN); International Business Machines Corporation, Armonk, NY (US)

(21) Appl. No.: 14/196,088

(22) Filed: Mar. 4, 2014

(51) Int. Cl. G01W 1/10

(52) U.S. Cl. CPC G01W 1/10

(57) ABSTRACT

Methods, systems, and articles of manufacture for generating an ensemble of forecasting models are provided herein. A method includes identifying a given environmental event from multiple items of input data; estimating an accuracy value for each of multiple forecasting models applied to an environmental event related to the given environmental event based on historical data; computing a cost and one or more resource requirements for each of the multiple forecasting models; and determining an ensemble of one or more of the multiple forecasting models to apply to the given environmental event based on (i) said estimated accuracy value for each of the multiple forecasting models, and (ii) said cost and said one or more resource requirements for each of the multiple forecasting models.

### FIELD OF THE INVENTION

Embodiments of the invention generally relate to information technology, and, more particularly, to environmental modeling.

### BACKGROUND

Environmental modeling includes implementing a mathematical model that describes the atmosphere in terms of temperature, pressure, humidity, etc. Numerical weather prediction involves solving equations based on such mathematical models on a four-dimensional grid (dimensions including, for example, latitude, longitude, altitude and time). Additionally, operational weather forecasting primarily relies on ensembles of weather models to account for the stochastic nature of weather processes, that is, to resolve inherent uncertainty.

Environmental modeling is commonly a labor-intensive process that requires the use of high performance computing (HPC) systems. Pay-as-you-go HPC accounts and cloud-based on-demand computing offer more cost-effective alternatives to ownership of HPC systems, but such accounts require the ability to forecast computational demand.

Additionally, operational forecasting requires a careful choice of ensemble models because not all models are suitable for all conditions and/or weather events. In some instances, relatively coarse resolution models can suffice for typical day-to-day forecasting. However, event-specific fine-resolution models are often required for extreme events (hurricanes, floods, etc.) that can have considerable socio-economic impact. Also, accurate forecasts with sufficient lead time are required to run subsequent models that depend on such forecasts. Fine-resolution models require considerable computational resources that can be expensive. In existing approaches, making a model choice is determined manually in an ad hoc fashion, or is based exclusively on model accuracy (for example, via vector breeding) without considering computational or socio-economic costs.

Accordingly, a need exists for modeling by determining optimal set of models to run depending on parameters such as weather conditions and user requirements.

### SUMMARY

In one aspect of the present invention, techniques for generating an ensemble of forecasting models are provided. An exemplary computer-implemented method can include steps of identifying a given environmental event from multiple items of input data; estimating an accuracy value for each of multiple forecasting models applied to an environmental event related to the given environmental event based on historical data; computing a cost and one or more resource requirements for each of the multiple forecasting models; and determining an ensemble of one or more of the multiple forecasting models to apply to the given environmental event based on (i) said estimated accuracy value for each of the multiple forecasting models, and (ii) said cost and said one or more resource requirements for each of the multiple forecasting models.

In another aspect of the invention, an exemplary computer-implemented method can include steps of estimating, based on historical data, an accuracy value for each of multiple forecasting models across multiple parameterizations applied to an environmental event related to a given environmental event; and computing, based on historical data, a computational cost and one or more resource requirements for each of the multiple forecasting models across multiple parameterizations. The method also includes steps of determining an ensemble of one or more of the multiple forecasting models and a parameterization for each of the one or more of the multiple forecasting models to apply to the given environmental event, wherein said determining is based on (i) said estimated accuracy value for each of the multiple forecasting models, (ii) said computational cost and said one or more resource requirements for each of the multiple forecasting models, (iii) availability of budget and one or more computational resources, and (iv) a specified forecast lead time parameter; and applying the ensemble of forecasting models to the given environmental event to generate a forecast.

Another aspect of the invention or elements thereof can be implemented in the form of an article of manufacture tangibly embodying computer readable instructions which, when implemented, cause a computer to carry out a plurality of method steps, as described herein. Furthermore, another aspect of the invention or elements thereof can be implemented in the form of an apparatus including a memory and at least one processor that is coupled to the memory and configured to perform noted method steps. Yet further, another aspect of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram illustrating an example embodiment, according to an aspect of the invention;

FIG. 2 is a flow diagram illustrating techniques according to an embodiment of the invention; and

FIG. 3 is a system diagram of an exemplary computer system on which at least one embodiment of the invention can be implemented.

### DETAILED DESCRIPTION

As described herein, an aspect of the present invention includes generating and recommending forecasting models for ensembles. Given a collection of forecasting models (such as weather models, hydrology models, climate models, etc.), historically-related observations, current model forecasts, socio-economic cost models, and/or user constraints on forecast lead time and computational resources, at least one embodiment of the invention includes determining an optimal ensemble of models and corresponding model configurations to be run in a given situation.

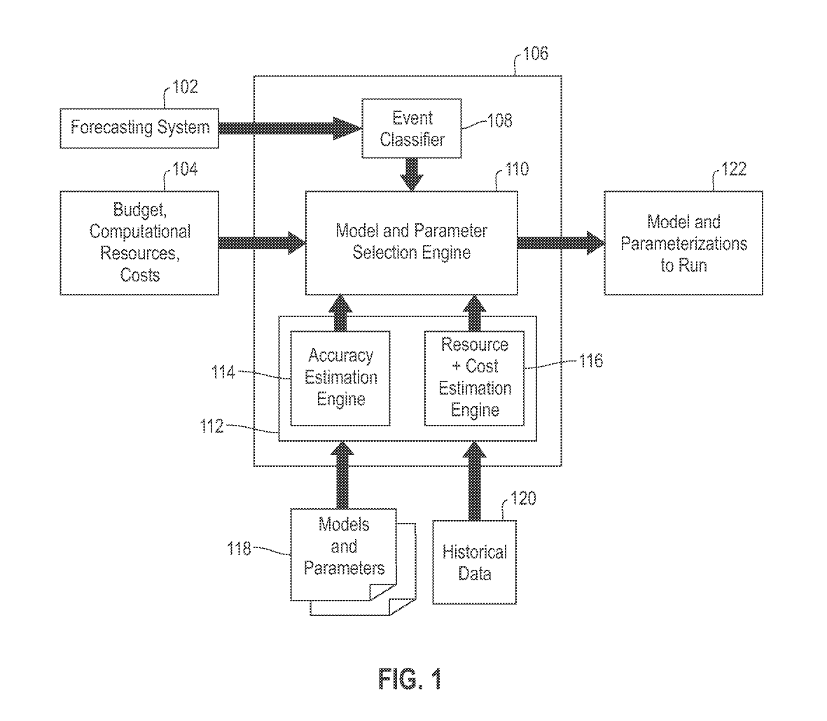

FIG. 1 is a block diagram illustrating an example embodiment, according to an aspect of the invention. By way of illustration, FIG. 1 depicts a model recommendation system 106, which includes an event classifier component 108, a model and parameter selection engine 110, and an estimation component 112 which includes an accuracy estimation engine 114 and a resource and cost estimation engine 116. As illustrated in FIG. 1, a forecasting system 102 provides input to the event classifier component 108. The input that the forecasting system 102 provides can include, for example, information that is similar to what a weather model might provide. Commonly, this can include output variables such as temperature, humidity, pressure, wind speed and direction, precipitation, etc.

Additionally, the estimation component 112 receives input in the form of models and parameters 118 as well as relevant historical data 120. The parameters noted via component 118 refer to weather model configuration parameters such as time-step, spatial resolution, cumulus physics schemes, micro-physics options, etc. For each model configuration, there will be a corresponding set of parameters associated therewith. As detailed herein, the accuracy estimation engine 114 uses past weather outputs of various models and parameter combinations and compares such data with observed historical data to determine a suitable set of model configurations for the event under consideration. A form of historical data that can be utilized includes the computational time, memory and hardware resources required for each model configuration, as well as the socio-economic impact of the event under consideration.

Further, as also depicted in FIG. 1, based on the above-noted input received, the event classifier component 108, the accuracy estimation engine 114 and the resource and cost estimation engine 116 provide input to the model and parameter selection engine 110, which also receives input in the form of budget information, computational resource information, and cost information 104. Based on these received inputs, the model and parameter selection engine 110 outputs a recommendation of one or more models and parameterizations 122 to run.

Additionally, the event classifier component 108 scans the forecast output (for example, hour-by-hour or per other units of time as determined by the resolution of the forecast) and determines if any events are indicated in the forecast, as detailed further herein. In such instances wherein events are indicated, the event classifier component 108 associates a label with the forecast output along with the time of the event occurrence. The output of the event classifier component 108 includes an event list comprising of [event label, event time] pairs. Examples of event labels can include (but are not limited to) “Heavy rainfall,” “Hurricane,” “Thunder storms,” “Cyclones,” “Strong winds,” etc.

In at least one example embodiment of the invention, the event classifier component 108 can include a manual component, wherein an expert examines data and creates an event list. Alternatively, in at least one example embodiment of the invention, the event classifier component 108 includes an automated component, wherein a user can specify [criteria, event label] pairs. An example might include user instructions such as [criteria=“more than 60 millimeters (mm) of precipitation in a two-hour window,” event label=“Heavy Rainfall”], indicating that more than 60 mm of rainfall in a two-hour window should be flagged as a heavy rainfall event.

Additionally, at least one embodiment of the invention includes scanning the forecast output hour-by-hour (or minute-by-minute, for example, depending on the resolution of the forecast) and determining if any of the criteria associated with the labels are satisfied. If matching criteria are found at some instance of time, then the corresponding event label, along with the time at which the event was identified, is added to the event list to be output.

Additionally, in at least one embodiment of the invention, the event classifier component 108 automatically generates events using anomaly detection (for example, with extreme value theory). As used herein, an event includes the value of one or more variables of interest at one or more time points (for example, a time series of vector values).

At least one embodiment of the invention also includes extracting a time series of vector values of a different set of (possibly overlapping) variables prior to a given event. These values can be extracted from sources of available data such as prior runs of a coarse model, available sensor data, etc. Using these vectors of time series, the event classifier component 108 (and/or a regressor) can be trained to signify presence and/or magnitude of events.

Additionally, at least one embodiment of the invention includes using historical wind speeds and wind pressures at different heights (for example, from a coarse model) to train a classifier for extreme wind events and ramps. The training data can include events labeled as detailed above. Also, in at least one embodiment of the invention, the event classifier includes a support vector machine (SVM). During run-time, the SVM takes inputs at each time step of the same time series of historical values and outputs a one (1) if an extreme event (for example, an extreme wind event) is predicted.

With respect to the accuracy estimation engine 114, as depicted in FIG. 1, relevant historical data can include, for example, weather forecast output results (precipitation, humidity, etc.) from previous runs of the forecasting models, and actual observed values for weather parameters (precipitation, humidity, etc.) as obtained from a meteorological department, sensors, or other sources. The accuracy estimation engine 114 uses such historical data to determine the accuracy of the forecasting models for different types of events. To do this, the accuracy estimation engine 114, for every model and event type, scans previous forecasts and filters those runs for which the corresponding observed values indicate occurrence of the selected event. For these runs of the model, the accuracy estimation engine 114 compares the model output parameters with the observable parameters. Based on this comparison, the accuracy estimation engine 114 computes an accuracy score measuring the accuracy of the specific run (for example, by computing the Root Mean Squared Error (RMSE) over the predictions for all of the observations). Also, the accuracy estimation engine 114 combines the accuracy scores for all of the runs to obtain an accuracy score for the [model, event] pair (for example, by averaging the runs). The output of the accuracy estimation engine 114 includes, for example, a list of accuracy scores for all [model, event] pairs.

The accuracy estimation engine 114 can also output a set of model configuration parameters suited for an event primarily based on accuracy scores. However, there can be a number of additional factors that determine the feasibility of running the entire list of model configurations. The resource and cost estimation engine 116, as depicted in FIG. 1, can be used to decide on the feasibility of running a configuration based on user-specified constraints. Examples of user-specified constraints can include the available number of processors, total memory available, model output required in under two hours, etc. Based on historical data pertaining, for example, to computational run-times, memory requirements, and hardware resource information, at least one embodiment of the invention includes creating models for hardware configuration and/or computation time/memory cost for a particular model configuration. For this purpose, at least one embodiment of the invention includes selecting features that describe a particular weather model configuration. This can include categorical features corresponding to various parameters such as physics options, cumulus parameterization, etc., or valued features such as number of grid points, time-step used, clock frequency of the processors, etc.

Consider the following example embodiment of the invention incorporating the resource and cost estimation engine 116 that assumes that all remaining weather parameters are the same. Let Nₓ*N_{y} be the size of computational domain. Let Pₓ*P_{y} be the hardware configuration. A support vector regression model for computational time can be generated using Nₓ*N_{y}/Pₓ*P_{y}, NₓP_{y}/PₓN_{y}, Nₓ/Pₓ+N_{y}/P_{y} as features and computational run-times as the target variable.

The model and parameter selection engine 110 determines the final set of model configurations for a particular event. This selection depends on multiple factors such as socio-economic cost associated with the event and the lead times required for an accurate forecast, as well as the user-specified constraints on cost and computational resource availability. As noted, the resource and cost estimation engine 116 computes the computational time and/or memory and resource requirements for each model configuration. All model configurations that do not meet user-specified constraints are flagged as infeasible. The set of possible model configurations is further pruned based on lead time requirements.

Consider the following example embodiment of the invention wherein a user places an upper limit of one hour for each simulation and a limit of five hours for the final ensemble output for a potential strong wind event. In such an example embodiment, the list of model configurations is sorted in increasing order by RMSE scores on wind speed. For each model configuration in sorted order, the expected computation time is computed using resource and cost estimation engine 116 data, and the model configurations that do not meet the upper limit of one hour are flagged as infeasible. The list is then traversed in sorted order of accuracy, and the list of feasible configurations is returned such that the total expected computational run-times for all configurations in the list is under five hours.

Also, at least one embodiment of the invention includes a model parameter regression. Models can be parameterized in multiple ways. By way of example, weather model physics parameterizations can be categorized in a modular way as follows: microphysics, cumulus parameterizations, surface physics, planetary boundary layer physics and atmospheric radiation physics. Parameterization, as used herein, includes weights and/or reliabilities associated with different models, which can be used to combine forecasts from multiple models.

Referring back to FIG. 1, the resource and cost estimation engine 116 estimates various parameters effecting the cost of running the model recommendation system 106. At least one embodiment of the invention includes building a regression model using support vector regression (SVR), which takes as features the total number of points in the domain, given by nₓ/n_{y}, the aspect ratio of the domain, given by nₓ=n_{y}, and the number of processors. Additionally, at least one embodiment of the invention includes building a regression model for different numbers of processors N within a range of Npₘᵢₙ to Npₘₐₓ. Also, costs can be calculated based on the cost of blocking N processors either in a shared compute environment or a cloud cluster. Accordingly, at least one embodiment of the invention includes estimating the optimal resource and cost for different execution times. The cost minimizing configuration can be selected based on the budget and computational resources available, as well as on the predicted time of the event from the event classifier component 108.

In accordance with the example embodiment depicted in FIG. 1, the accuracy estimation engine 114 determines how well noted models perform for various events, which can include identifying events in historical observation data and, for such events, estimating the accuracy of the model output during the event. Event identification is based on labeled historical observation data, and can be implemented via techniques similar to those detailed above in connection with the event classifier component 108. Additionally, accuracy estimation can include using a RMSE between the observed data and the model output at the time of the event (available from historical data).

In further reference to FIG. 1, and as detailed herein, the model and parameter selection engine 110 determines, based on the identified event (from the event classifier 108), the estimated accuracy for the event (from the accuracy estimation engine 114) and the estimated resource requirement and cost (from the resource and cost estimation engine 116), an ensemble of models and parameterizations that are suited for the given event, as well as the availability of budget and/or computational resources.

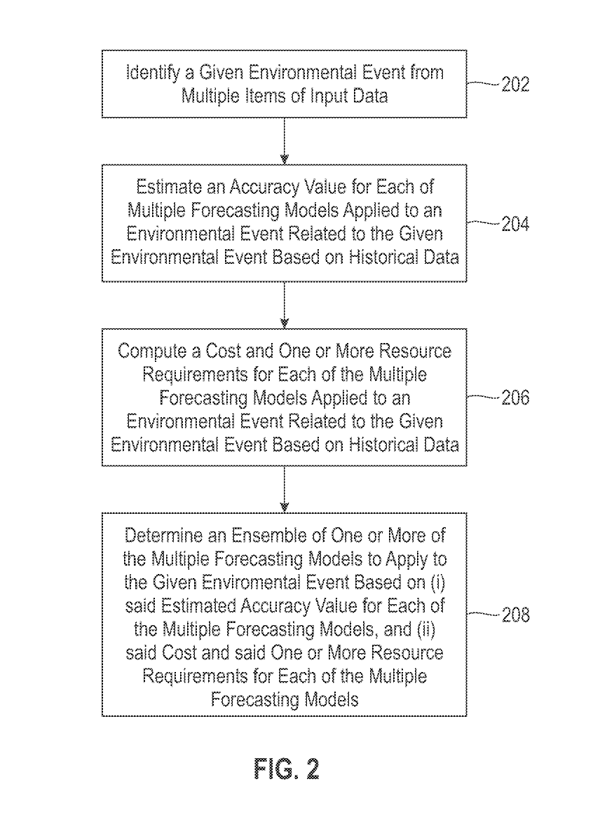

FIG. 2 is a flow diagram illustrating techniques according to an embodiment of the present invention. Step 202 includes identifying a given environmental event (for example, a weather-related event) from multiple items of input data. Input data can include, for example, previous forecasts, time-related data, an upper limit on cost, and risk-related data.

Step 204 includes estimating an accuracy value for each of multiple forecasting models applied to an environmental event related to the given environmental event based on historical data. Estimating can include estimating the accuracy value for each of the multiple forecasting models across multiple parameterizations. Additionally, estimating can be carried out online and/or offline.

Step 206 includes computing a cost and one or more resource requirements for each of the multiple forecasting models. Computing can include computing the cost and the one or more resource requirements for each of the multiple forecasting models across multiple parameterizations. Additionally, in at least one embodiment of the invention, the cost includes a cost related to an incorrect forecast produced by each of the multiple forecasting models applied to an environmental event related to the given environmental event.

Step 208 includes determining an ensemble of one or more of the multiple forecasting models to apply to the given environmental event based on (i) said estimated accuracy value for each of the multiple forecasting models, and (ii) said cost and said one or more resource requirements for each of the multiple forecasting models. The determining step can include determining an ensemble of one or more of the multiple forecasting models and a parameterization for each of the one or more of the multiple forecasting models to apply to the given environmental event.

The techniques depicted in FIG. 2 can also include applying the ensemble of forecasting models to the given environmental event to generate a forecast. Such techniques can also include managing each of the one or more forecasting models in the ensemble during application of the ensemble to the given environmental event.

Further, at least one embodiment of the invention includes estimating, based on historical data, an accuracy value for each of multiple forecasting models across multiple parameterizations applied to an environmental event related to a given environmental event, and computing, based on historical data, a computational cost and one or more resource requirements for each of the multiple forecasting models across multiple parameterizations. Such an embodiment additionally includes determining an ensemble of one or more of the multiple forecasting models and a parameterization for each of the one or more of the multiple forecasting models to apply to the given environmental event, wherein said determining is based on (i) said estimated accuracy value for each of the multiple forecasting models, (ii) said computational cost and said one or more resource requirements for each of the multiple forecasting models, (iii) availability of budget and one or more computational resources, and (iv) a specified forecast lead time parameter. Further, such an embodiment can include applying the ensemble of forecasting models to the given environmental event to generate a forecast.

The techniques depicted in FIG. 2 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an aspect of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 2 can be implemented via a computer program product that can include computer useable program code that is stored in a computer readable storage medium in a data processing system, and wherein the computer useable program code was downloaded over a network from a remote data processing system. Also, in an aspect of the invention, the computer program product can include computer useable program code that is stored in a computer readable storage medium in a server data processing system, and wherein the computer useable program code is downloaded over a network to a remote data processing system for use in a computer readable storage medium with the remote system.

An aspect of the invention or elements thereof can be implemented in the form of an apparatus including a memory and at least one processor that is coupled to the memory and configured to perform exemplary method steps.

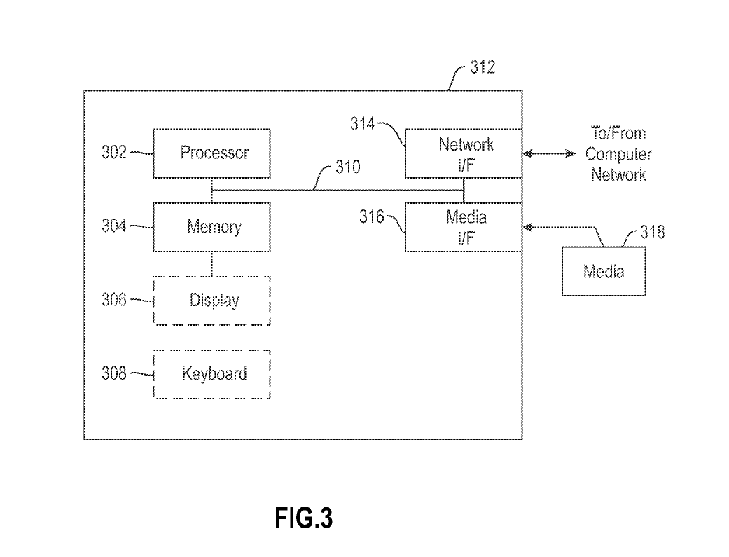

Additionally, an aspect of the present invention can make use of software running on a general purpose computer or workstation. With reference to FIG. 3, such an implementation might employ, for example, a processor 302, a memory 304, and an input/output interface formed, for example, by a display 306 and a keyboard 308. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 302, memory 304, and input/output interface such as display 306 and keyboard 308 can be interconnected, for example, via bus 310 as part of a data processing unit 312. Suitable interconnections, for example via bus 310, can also be provided to a network interface 314, such as a network card, which can be provided to interface with a computer network, and to a media interface 316, such as a diskette or CD-ROM drive, which can be provided to interface with media 318.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 302 coupled directly or indirectly to memory elements 304 through a system bus 310. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including but not limited to keyboards 308, displays 306, pointing devices, and the like) can be coupled to the system either directly (such as via bus 310) or through intervening I/O controllers (omitted for clarity).

Network adapters such as network interface 314 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 312 as shown in FIG. 3) running a server program. It will be understood that such a physical server may or may not include a display and keyboard.

As will be appreciated by one skilled in the art, aspects of the present invention may be embodied as a system, method and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, as noted herein, aspects of the present invention may take the form of a computer program product that may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 302. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed general purpose digital computer with associated memory, and the like. Given the teachings of the invention provided herein, one of ordinary skill in the related art will be able to contemplate other implementations of the components of the invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of another feature, integer, step, operation, element, component, and/or group thereof.

The corresponding structures, materials, acts, and equivalents of all means or step plus function elements in the claims below are intended to include any structure, material, or act for performing the function in combination with other claimed elements as specifically claimed.

At least one aspect of the present invention may provide a beneficial effect such as, for example, determining an optimal ensemble of models and corresponding model configurations.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
identifying a given environmental event from multiple items of input data;
estimating an accuracy value for each of multiple forecasting models applied to an environmental event related to the given environmental event based on historical data;
computing a cost and one or more resource requirements for each of the multiple forecasting models; and
determining an ensemble of one or more of the multiple forecasting models to apply to the given environmental event based on (i) said estimated accuracy value for each of the multiple forecasting models, and (ii) said cost and said one or more resource requirements for each of the multiple forecasting models;
wherein at least one of said identifying, said estimating, said computing, and said determining is carried out by a computing device.

2. The method of claim 1, wherein said estimating comprises estimating the accuracy value for each of the multiple forecasting models across multiple parameterizations.

3. The method of claim 1, wherein said computing comprises computing the cost and the one or more resource requirements for each of the multiple forecasting models across multiple parameterizations.

4. The method of claim 1, comprising:
determining a parameterization for each of the one or more of the multiple forecasting models to apply to the given environmental event.

5. The method of claim 1, wherein said multiple items of input data comprise multiple previous forecasts.

6. The method of claim 1, wherein said multiple items of input data comprise at least an upper limit on cost.

7. The method of claim 1, wherein said estimating comprises estimating the accuracy value for each of the multiple forecasting models online.

8. The method of claim 1, wherein said estimating comprises estimating the accuracy value for each of the multiple forecasting models offline.

9. The method of claim 1, comprising:
applying the ensemble of forecasting models to the given environmental event to generate a forecast.

10. The method of claim 1, wherein said cost comprises a cost related to an incorrect forecast produced by each of the multiple forecasting models applied to the environmental event related to the given environmental event.

11. An article of manufacture comprising a computer readable storage medium having computer readable instructions tangibly embodied thereon which, when implemented, cause a computer to carry out a plurality of method steps comprising:
identifying a given environmental event from multiple items of input data;
estimating an accuracy value for each of multiple forecasting models applied to an environmental event related to the given environmental event based on historical data;
computing a cost and one or more resource requirements for each of the multiple forecasting models applied to the environmental event related to the given environmental event based on historical data; and
determining an ensemble of one or more of the multiple forecasting models to apply to the given environmental event based on (i) said estimated accuracy value for each of the multiple forecasting models, and (ii) said cost and said one or more resource requirements for each of the multiple forecasting models.

12. The article of manufacture of claim 11, wherein said estimating comprises estimating the accuracy value for each of the multiple forecasting models across multiple parameterizations.

13. The article of manufacture of claim 11, wherein said computing comprises computing the cost and the one or more resource requirements for each of the multiple forecasting models across multiple parameterizations.

14. The article of manufacture of claim 11, wherein said plurality of method steps comprises:
determining a parameterization for each of the one or more of the multiple forecasting models to apply to the given environmental event.

15. The article of manufacture of claim 11, wherein said estimating comprises estimating the accuracy value for each of the multiple forecasting models online.

16. The article of manufacture of claim 11, wherein said estimating comprises estimating the accuracy value for each of the multiple forecasting models offline.

17. The article of manufacture of claim 11, wherein said plurality of method steps comprises:
applying the ensemble of one or more of the multiple forecasting models to the given environmental event to generate a forecast.

18. The article of manufacture of claim 11, wherein said cost comprises a cost related to an incorrect forecast produced by each of the multiple forecasting models applied to the environmental event related to the given environmental event.

19. A system comprising:
a memory; and
at least one processor coupled to the memory and configured for:
identifying a given environmental event from multiple items of input data;
estimating an accuracy value for each of multiple forecasting models applied to an environmental event related to the given environmental event based on historical data;
computing a cost and one or more resource requirements for each of the multiple forecasting models applied to the environmental event related to the given environmental event based on historical data; and
determining an ensemble of one or more of the multiple forecasting models to apply to the given environmental event based on (i) said estimated accuracy value for each of the multiple forecasting models, and (ii) said cost and said one or more resource requirements for each of the multiple forecasting models.

20. A method comprising:
estimating, based on historical data, an accuracy value for each of multiple forecasting models across multiple parameterizations applied to an environmental event related to a given environmental event;
computing, based on historical data, a computational cost and one or more resource requirements for each of the multiple forecasting models across multiple parameterizations;
determining an ensemble of one or more of the multiple forecasting models and a parameterization for each of the one or more of the multiple forecasting models to apply to the given environmental event, wherein said determining is based on (i) said estimated accuracy value for each of the multiple forecasting models, (ii) said computational cost and said one or more resource requirements for each of the multiple forecasting models, (iii) availability of budget and one or more computational resources, and (iv) a specified forecast lead time parameter; and
applying the ensemble of forecasting models to the given environmental event to generate a forecast;
wherein at least one of said estimating, said computing, said determining, and said applying is carried out by a computing device.
